(19) United States
(12) Patent Application Publication
(10) Pub. No.: US 2005/0045852 A1
(43) Pub. Date: Mar. 3, 2005

(54) Particle-free polishing fluid for nickel-based coating planarization

(76) Inventors: Joseph G. Ameen, Newark, DE (US); Dave Huynh, Newark, DE (US); Zhendong Liu, Newark, DE (US); John Quanci, Haddonfield, NJ (US); Lillian Vespa, Newark, DE (US)

Correspondence Address: Rodel Holdings, Inc., Suite 1300, 1105 North Market Street, Wilmington, DE, 19899, US

(21) Appl. No.: 10/652,176

(22) Filed: Aug. 29, 2003

(51) Int. Cl. B24B 1/00; B24B 7/19; B24B 7/30; C09K 13/00

(52) U.S. Cl. 252/79.1

(57) ABSTRACT

A particle-free polishing fluid for planarizing nickel or nickel-alloy coating on substrates is disclosed. The particle-free polishing fluid contains at least one oxidizing agent, or mixtures thereof. The particle-free polishing fluid may also contain an accelerating agent and/or a complexing agent. Surface roughnesses of less than about 1.51 Å are possible when polishing magnetic disks with the particle-free polishing fluid in a final step polishing process.

### BACKGROUND OF THE INVENTION

The invention relates to chemical-mechanical-polishing (CMP) and, more particularly, to a particle-free polishing fluid (“reactive liquid”) for planarizing a nickel-based coating used in applications, such as, in the manufacture of memory hard disks.

Most modern-day computers have a magnetic memory disk (“hard disk”) for storing and retrieving a variety of information. The memory disks are rigid and typically made from an aluminum alloy substrate with a nickel (Ni) or nickel alloy such as nickel-phosphorous (Ni—P) coating layer. The coating layer is formed by electroplating and typically has a rough surface. The coating layer thus needs to be polished or “planarized” before the active magnetic surface coating is applied.

The preferred method of planarizing the Ni or nickel alloys such as Ni—P coating is chemical-mechanical planarization or CMP. Chemical-mechanical-polishing is a process of removing material from a surface of, for example, a magnetic disk, with a polishing pad and a polishing fluid (slurry). When polishing a magnetic disk, the magnetic surface is typically abraded by contact with a polishing pad and with abrasive particles. The abrasive particles may be present in the pad and/or in the slurry. The removal of material from the magnetic surface is also a result of chemical reactions between the surface material and reactive ingredients in the slurry.

Ideally, when a surface is polished, material is removed only from the physical peaks on the surface. The smoothness of a surface can be measured in terms of surface roughness, noted as “Ra” and expressed in units of length. Typical Ra values from conventional CMP processing of magnetic disks are from 2-5 angstroms (A).

Unfortunately, conventional polishing slurries contain abrasive particles, as discussed above, and can cause undesirable scratching of the magnetic disk surface. Consequently, conventional slurries are incapable of providing surface roughness values below 2 Å. This is especially problematic during a final step polish process. To this end, smaller and/or softer particles are utilized to reduce the surface scratching and larger and/or harder abrasives, such as, aluminum oxide have been replaced by smaller and/or softer abrasives, for example, colloidal silica and fumed metal oxides. However, these smaller and/or softer abrasives will still leave unwanted scratches and/or surface roughness after the final polish.

Hence, what is needed is a polishing fluid that reduces or eliminates scratches and/or surface roughness on the final, polished surface, for example, of a magnetic disk. Further, what is needed is a slurry that provides for surface roughness values at least below 2 Å.

### STATEMENT OF THE INVENTION

In one aspect, the present invention provides a particle-free polishing fluid for planarizing nickel or nickel-alloy coating on substrates, the polishing fluid comprising: an aqueous solution containing at least an oxidizing agent, or mixtures thereof, wherein the oxidizing agent is selected from the group comprising: oxidizing metal salts, oxidizing metal complexes, peroxides, chlorates, perchlorates, perbromates, periodates, permanganates, sulfates, persulfates, and monopersulfates.

In a second aspect, the present invention provides a particle-free polishing fluid for planarizing nickel or nickel-alloy coating on substrates, the polishing fluid comprising: an aqueous solution containing at least an oxidizing agent, or mixtures thereof, wherein the oxidizing agent is selected from the group comprising: oxidizing metal salts, oxidizing metal complexes, peroxides, chlorates, perchlorates, perbromates, periodates, permanganates, sulfates, persulfates, and monopersulfates; an accelerating agent; and a complexing agent.

In a third aspect, the present invention provides a method of planarizing a nickel or nickel-alloy coated substrate, the method comprising: a) dispensing onto a polishing pad a particle-free polishing fluid comprising an aqueous solution of at least an oxidizing agent, or mixtures thereof, wherein the oxidizing agent is selected from the group comprising: oxidizing metal salts, oxidizing metal complexes, peroxides, chlorates, perchlorates, perbromates, periodates, permanganates, sulfates, persulfates, and monopersulfates; b) moving the coated substrate to the polishing pad containing the particle-free polishing fluid thereon; and c) moving the coated substrate relative to the polishing pad to reduce surface roughness of the magnetic disk surface.

### DETAILED DESCRIPTION

In a preferred embodiment of the invention, a particle-free polishing fluid is formulated with an oxidizing agent. As used herein, a “particle-free” polishing fluid or a “reactive liquid” is defined herein as a polishing fluid having essentially no abrasive matter, component, etc. contained therein. Preferred oxidizing agents include persulfates, monopersulfates, and hydrogen peroxide. When used in a final (second) chemical-mechanical-polishing step on the surface of a magnetic disk, such as a disk coated with a nickel phosphorus (NiP) layer, the surface roughness can be reduced to the order of 1-2 angstroms (Å) or less. Note, although the invention will be described in regards to Ni and Ni-alloy coatings (e.g., Ni—P) on memory hard disks, the invention is not so limited. Rather, the present invention is fully intended to be equally applicable to any other application wherein a nickel or nickel-alloy, that is formed on a substrate, is desired to be planarized. For example, the present invention can be utilized in, for example, an integrated circuit application wherein the conductive plugs in an interconnect system are formed by Ni alloy, for example, Ni—P.

Although a wide range of oxidizing agents may be used, preferred oxidizing agents include oxidizing metal salts; oxidizing metal complexes such as potassium ferricyanide; peroxides; salts of aluminum, sodium, potassium, ammonium, or phosphonium with chlorates, perchlorates, perbromates, periodates, permanganates, sulfates, persulfates (also known as “dipersulfates”, S₂O₈⁻²), or monopersulfates (HSO₅⁻¹); and the like; and mixtures thereof. Specific examples of oxidizing agents include KIO₄, NaIO₄, KHSO₅, NaHSO₅, (NH₄)HSO₅, (NH₄)₂S₂O₈, K₂S₂O₈, Na₂S₂O₈, KMnO₄, Al(ClO₄)₃, KClO₄, NaClO₄, and NH₄ClO₄, H₂O₂, benzoyl peroxide, di-t-butyl peroxide, sodium peroxide, and the like. Further oxidizing agents include, hydrogen peroxide; persulfates such as sodium persulfate, potassium persulfate, and ammonium persulfate; and monopersulfates such as sodium monopersulfate, potassium monopersulfate, and ammonium monopersulfate; and the like. An example of a commercially available oxidizing agent containing a mixture of substances is OXONE® (DUPONT, Wilmington, Del.), which is a mixture of KHSO₅, KHSO₄, and K₂SO₄ in a weight ratio of approximately 2:1:1.

The oxidizing agent may be present in the polishing fluid in a wide range of concentrations. Preferably the concentration of the oxidizing agent in the aqueous fluid is from about 0.1 percent by weight (wt %) to about 10 wt %, more preferably from about 0.2 wt % to about 7 wt %, and more preferably still from about 0.3 wt % to about 5 wt %. It may be desirable to include more than one oxidizing agent in the reactive liquid. For example, a peroxide may be used in combination with a persulfate or a monopersulfate. When mixtures of oxidizing agents are used, they are preferably present in a total concentration of from about 0.1 wt % to about 10 wt %, more preferably from about 0.2 wt % to about 7 wt %, and more preferably still from about 0.3 wt % to about 5 wt %.

An aqueous mixture of the oxidizing agent may be used without any other additives to produce a polished surface. Other agents may be added to the mixture as well, including accelerating agents (or catalysts) and complexing agents. Examples of accelerating agents include nitrate compounds, such as HNO₃, Ni(NO₃)₂, Al(NO₃)₂, Mg(NO₃)₂, Zn(NO₃)₂, Fe(NO₃)₃, Fe(NO₃)₃9H₂O, NH₄NO₃, and the like, and mixtures thereof. Preferably, the concentration of the accelerating agent in the particle-free polishing fluid is up to about 3 wt %, more preferably from about 0.05 wt % to about 0.7 wt %, and more preferably still from about 0.1 wt % to about 0.5 wt %.

Examples of complexing agents include carboxylic acids such as acetic acid, citric acid, glycolic acid, lactic acid, malic acid, oxalic acid, salicylic acid, succinic acid, tartaric acid, thioglycolic acid, aspartic acid, malonic acid, gluteric acid, 3-hydroxybutyric acid, propionic acid, phthalic acid, isophthalic acid, 3-hydroxy salicylic acid, 3,5-dihydroxy salicylic acid, gallic acid, gluconic acid, gallic acid, tannic acid, and salts thereof; amino acids such as glycine, alanine, ethylene diamine tetraacetic acid (EDTA), and salts thereof; amines such as ethylene diamine, trimethylene diamine, and salts thereof; ammonium compositions including ammonium salts and quaternary ammonium salts; ethyl acetoacetate; sodium diethyl dithiocarbamate; pyrocatechol; pyrogallol; and the like; and mixtures thereof (i.e. ammonium citrate). Preferably, the concentration of the complexing agent in the particle-free polishing slurry is up to about 2 wt %, more preferably from about 0.1 wt % to about 1.5 wt %, and more preferably still from about 0.2 wt % to about 1 wt %.

An exemplary formulation contains 1.5 wt % OXONE® (potassium monopersulfate mixture), 0.5 wt % ammonium citrate, 0.5 wt % ferric nitrate nonahydrate, and 0.9 wt % of hydrogen peroxide. This is an aqueous formulation having a pH of 2.41, which is titrated with nitric acid to a pH of 2.3. No particles were added to the formulation. This reactive liquid, when applied to a polished NiP disk surface with a DPM2000 polishing pad, reduced the surface roughness from a Ra of 2.40 Å to a Ra of 1.77 Å. Preferably the particle-free polishing fluid can produce a final surface roughness of less than about 2 Å, more preferably less than about 1.5 Å, more preferably still less than 1.2 Å.

A variety of polishing conditions may be used with the polishing fluid of the present invention. The speed of the polishing pad can vary from about 5 to about 300 revolutions per minute (rpm). Preferably the speed of the polishing pad is from about 10 rpm to 200 rpm, more preferably from about 15 rpm to about 100 rpm. The down force applied to the substrate by the polishing pad can vary from about 0.1 pounds per square inch (psi) to about 10 psi. Preferably, the down force is from about 0.5 psi to about 7 psi, more preferably from about 1 psi to about 5 psi. The flow rate of the polishing fluid can vary from about 10 cubic centimeters per minute (cc/min) to about 300 cc/min. Preferably, the polishing fluid flow rate is from about 20 cc/min to about 200 cc/min, and more preferably from about 50 cc/min to about 150 cc/min.

The polish time required to achieve the desired roughness will vary based on processing parameters such as the ingredients of the polishing fluid, the speed of the polishing pad, the down force, and the polishing fluid flow rate. Under typical polishing conditions, the polish time can vary from about 0.5 minutes to about 20 min. Preferably, the polishing time is from about 1 min. to about 15 min., more preferably from about 3 min. to about 10 min. An exemplary set of polishing conditions includes a polishing pad speed of 25 rpm, a down force of 2 psi, a polishing fluid flow rate of 100 cc/min, and a polish time of 6 minutes.

The reactive liquid can be used to produce a planarized surface on a variety of substrates. For example, the substrate may be a non-magnetic material with a magnetic coating, or the entire substrate may be a magnetic material. Preferably, the substrate has a core of aluminum or glass, with a surface coating of glass, titanium, carbon, zirconium, silicon carbide, boron carbide, or NiP. More preferably, the substrate is NiP-coated aluminum or NiP-coated glass, and more preferably still is NiP-coated aluminum.

Preferably, the reactive liquid of the present invention is utilized in second step polishing of magnetic disk substrates. A second step of polishing is intended to remove small defects and irregularities in the surface to produce the final planarized surface layer. A first polishing step, performed prior to the second polishing step, may be used to remove larger defects and to eliminate periodic peaks and valleys across the surface. In a two-step polishing process, the first polishing step typically includes the use of abrasive particles. Any residual abrasive particles are preferably washed away from the surface before the second-step polishing with an abrasive-free polishing fluid.

Preferably, the polishing fluid for first step polishing contains submicron abrasive particles with a particle size up to about 100 nanometers (nm). Preferably, the abrasive particles are non-agglomerated and have a particle size from about 5 nm to about 100 nm, and more preferably from about 10 nm to about 40 nm, and most preferably from about 20 nm to about 30 nm. Additionally, the polishing fluid may contain various mixtures of the above particle sizes (e.g., Nalco 2360). Abrasives used in CMP polishing fluids include alumina, silica, ceria, germania, titania, zirconia, diamond, boron nitride, boron carbide, silicon carbide and combinations thereof.

Preferably, the first-step polishing fluid contains abrasive colloidal silica particles. Reducing the amount of abrasive particles in a polishing fluid usually results in a reduction in scratches and defects on the polished semiconductor wafer. However, a lower abrasive concentration typically reduces the rate of polishing. The abrasive concentration may be, for example, from about 0.05 wt. % to about 20 wt. %. Preferably, the abrasive concentration is from about 0.1 wt. % to about 15 wt. %, and more preferably from about 0.5 wt. % to about 10 wt. %, and most preferably from about 1 wt. % to about 5 wt. %.

In an example embodiment, the concentration and identity of the oxidizing agent in the polishing fluid is varied from the polishing of one magnetic disk to the polishing of another magnetic disk, or during the course of a single polishing step.

### EXAMPLES

### Example 1

### Reactive Liquid Containing Hydrogen Peroxide

A reactive liquid was prepared by mixing 0.15 percent by weight (wt %) Fe(NO₃)₃9H₂O, 0.45 wt % citric acid, 0.312 wt % H₂O₂, and 99.09 wt % water. The pH of the solution was adjusted to 2.3 by adding 10N NaOH or 15.8M HNO₃ as necessary.

### Example 2

### Reactive Liquid Containing Hydrogen Peroxide Without Complexing Agent

A reactive liquid was prepared as described in Example 1, except that all the citric acid was replaced with water (99.54 wt % water). The pH was adjusted to 2.3.

### Example 3

### Reactive Liquid Containing Hydrogen Peroxide Without Accelerating Agent

A reactive liquid was prepared as described in Example 1, except that all the Fe(NO₃)₃9H₂O was replaced with water (99.24 wt % water). The pH was adjusted to 2.3.

Polishing Tests With Reactive Liquids Containing H₂O₂

The reactive liquids of Examples 1-3 were independently applied to a NiP coated aluminum disk at a rate of 100 cc/min for 6 minutes, with a polishing pad speed of 25 rpm and a down force of 2 psi. The surface roughness values of the disks were measured, and the results are shown in Table 1, together with the compositions of the reactive liquids described in the Examples. Note, these examples are from first step polishing.

TABLE 1
Polishing With Reactive Liquids Containing H₂O₂ (Not Final Polish)

| | Example 1 | Example 2 | Example 3 |
|---|---|---|---|
| H₂O₂ | 0.312 wt. % | 0.312 wt % | 0.312 wt % |
| Fe(NO₃)₃9H₂O | 0.15 wt % | 0.15 wt % | 0 |
| Citric acid | 0.45 wt % | 0 | 0.45 wt % |
| Water | 99.09 wt % | 99.54 wt % | 99.24 wt % |
| Final pH | 2.3 | 2.3 | 2.3 |
| Ra | 1.89 Å | 3.09 Å | 2.04 Å |

Table 1 shows that a reactive liquid containing an oxidizing agent, an accelerating agent and a complexing agent can reduce the surface roughness of a magnetic disk to less than about 2 Å. In this analysis, the use of hydrogen peroxide as the oxidizing agent provided improved smoothness to the surface. Good smoothness (Ra=2.04 Å) was obtained when the reactive liquid contained hydrogen peroxide and a complexing agent. The optimum smoothness was obtained when the reactive liquid also contained Fe(NO₃)₃9H₂O as an accelerating agent and citric acid as a complexing agent.

Use of Reactive Liquid Containing H₂O₂ as Second Step Polishing Fluid

Disks having a coating of NiP over an aluminum substrate were subjected to a first polishing step with a polishing fluid containing particles. A polishing fluid was prepared as described in Example 1, and then 4 wt % colloidal silica was added (NALCO 2360; ONDEO-NALCO, Naperville, Ill.). The polishing fluid was applied at a rate of 100 cc/min for 6 minutes, with a polishing pad speed of 25 rpm and a down force of 2 psi.

When the polishing fluid of Example 1 was used with a standard DPM2000 polishing pad, the average total removal was 57.5 mg (±0.9), and the average surface roughness was 2.59 Å (±0.41). Then, a second step polishing using the reactive liquid of Example 1 (100 cc/min for 6 minutes, polishing pad speed of 25 rpm, down force of 2 psi) yielded an average total removal of 4.2 mg (±2.8) and an average surface roughness of 1.25 Å (±0.06).

In another test, the polishing fluid of Example 1 was used with a DMP2000 pad that had been impregnated with Witcobond and KLEBOSOL particles (Crompton Corp., Uniroyal Chemical, Inc., Middlebury, Conn.; Clariant Corp.). After this first polishing, the average total removal was 46.1 mg (±0.2), and the average surface roughness was 2.22 Å (±0.06). Then, a second step polishing using the reactive liquid of Example 1 (100 cc/min for 6 minutes, polishing pad speed of 25 rpm, down force of 2 psi) yielded an average total removal of 4.2 mg (±0.1) and an average surface roughness of 1.19 Å (±0.04).

The data shows that a reactive liquid containing an oxidizing agent can reduce the surface roughness of a previously polished magnetic disk from an Ra of about 2-3 Å to an Ra less than 1.3 Å. The improvements in surface roughness correspond to reductions in Ra of 52% for the first test and 46% for the second test. The second step polishing fluids used to achieve these results contained hydrogen peroxide as the oxidizing agent, together with an accelerating agent and a complexing agent.

### Example 4

### Reactive Liquid Containing Monopersulfate Mixture

A reactive liquid was prepared by mixing 1.5 wt % OXONE®, 0.9 wt % H₂O₂, and 97.6 wt % water. The pH of the solution was adjusted to 2.3 by adding ION NaOH or 15.8M HNO₃ as necessary.

### Example 5

### Reactive Liquid Containing Monopersulfate Mixture And Accelerating Agent

A reactive liquid was prepared as described in Example 4, except that 0.5 wt % Fe(NO₃)₃9H₂O was added, resulting in a water content of 97.1 wt %. The pH was adjusted to 2.3.

### Example 6

### Reactive Liquid Containing Monopersulfate Mixture And Complexing Agent

A reactive liquid was prepared as described in Example 5, except that 0.5 wt % ammonium citrate was added, resulting in a water content of 97.1 wt %. The pH was adjusted to 2.3.

### Example 7

### Reactive Liquid Containing Monopersulfate Mixture, Accelerating Agent, and Complexing Agent

A reactive liquid was prepared as described in Example 5, except that 0.5 wt % ammonium citrate was added, resulting in a water content of 96.6 wt %. The pH was adjusted to 2.3.

Polishing Tests With Reactive Liquids Containing Monopersulfate (Not Final Polish)

The polishing fluids of Examples 4-7 were independently applied to a NiP coated aluminum disk at a rate of 100 cc/min for 6 minutes, with a polishing pad speed of 25 rpm and a down force of 2 psi. The results are shown in Table 2, together with the compositions of the reactive liquids described in Examples 4 through 7.

TABLE 2
Polishing With Polishing Fluids Containing Monopersulfate Mixture

| | Example 4 | Example 5 | Example 6 | Example 7 |
|---|---|---|---|---|
| OXONE ® | 1.5 wt % | 1.5 wt % | 1.5 wt % | 1.5 wt % |
| H₂O₂ | 0.9 wt % | 0.9 wt % | 0.9 wt % | 0.9 wt % |
| Fe(NO₃)₃9H₂O | — | 0.5 wt % | — | 0.5 wt % |
| Ammonium | — | — | 0.5 wt % | 0.5 wt % |
| Citrate | | | | |
| Water | 97.6 wt % | 97.1 wt % | 97.1 wt % | 96.6 wt % |
| Final pH | 2.3 | 2.3 | 2.3 | 2.3 |
| Surface | 0 mg | 15.4 mg | 0 mg | 4.6 mg |
| Removal | | | | |
| Ra | 1.79 Å | 2.72 Å | 1.65 Å | 1.77 Å |

Table 2 shows that a reactive liquid containing a mixture of oxidizing agents and a complexing agent can reduce the surface roughness of a magnetic disk to less than about 2 Å. These polishing fluids contained a monopersulfate mixture as well as hydrogen peroxide as the oxidizing agents. The surface roughness was improved by the presence of a complexing agent (ammonium citrate) or by the presence of both a complexing agent and an accelerating agent (Fe(NO₃)₃9H₂O).

### Example 8

### Polishing Tests Containing Monopersulfate in a Final Step Polish

In a follow-up experiment, 7% Nalco 2360 particles were added to the reactive liquid of Example 4. The mixture was then used to pre-polish the disks. The reactive liquid of Example 4 was then used to final polish the disks again. The results are presented in Table 3 below. As shown, the reactive liquid utilized in a final polishing step provided a surface roughness measurement of 1.51 Å.

TABLE 3
Results of Example 4 in a Second Step Polishing Process

| Reactive Liquid | Ra (Å) |
|---|---|
| Example 4 | 1.79 |
| Example 4 used in final polishing step after pre-polish with 7% | 1.51 |
| Nalco 2360 particles. | |

Accordingly, the present invention provides a particle-free polishing fluid for performing a final chemical mechanical polishing of a magnetic disk. The polishing fluid comprises an aqueous solution containing at least an oxidizing agent, or mixtures thereof, wherein the oxidizing agent is selected from the group comprising: oxidizing metal salts, oxidizing metal complexes, peroxides, chlorates, perchlorates, perbromates, periodates, permanganates, sulfates, persulfates, and monopersulfates. The polishing fluid of the present invention ideally reduces or eliminates scratches and/or surface roughness on the final, polished surface. Further, the polishing fluid of the present invention provides for surface roughness values about 1.51 Å.

1. A particle-free polishing fluid for planarizing nickel or nickel-alloy coating on substrates, the polishing fluid comprising:
an aqueous solution containing at least an oxidizing agent, or mixtures thereof; wherein the oxidizing agent is selected from the group comprising: oxidizing metal salts, oxidizing metal complexes, peroxides, chlorates, perchlorates, perbromates, periodates, permanganates, sulfates, persulfates, and monopersulfates.

2. The particle-free polishing fluid of claim 1, wherein the oxidizing agent is selected from the group comprising: sodium persulfate, sodium monopersulfate, potassium persulfate, potassium monopersulfate, ammonium persulfate, ammonium monopersulfate, and hydrogen peroxide.

3. The particle-free polishing fluid of claim 1, further comprising an accelerating agent.

4. The particle-free polishing fluid of claim 3, wherein the accelerating agent is selected from the group comprising HNO₃, Ni(NO₃)₂, Al(NO₃)₂, Mg(NO₃)₂, Zn(NO₃)₂, Fe(NO₃)₃, Fe(NO₃)₃9H₂O and NH₄NO₃.

5. The particle-free polishing fluid of claim 1, further comprising a complexing agent.

6. The particle-free polishing fluid of claim 5, wherein the complexing agent is selected from the group comprising a carboxylic acid, an amino acid, an amine, an ammonium composition, ethyl acetoacetate, sodium diethyl dithiocarbamate, pyrocatechol, pyrogallol, and salts thereof.

7. The particle-free polishing fluid of claim 1, wherein the nickel or nickel-alloy coating is a conductive plug in an interconnect system of a semiconductor device.

8. A particle-free polishing fluid for planarizing nickel or nickel-alloy coating on substrates, the polishing fluid comprising:
an aqueous solution containing at least an oxidizing agent, or mixtures thereof, wherein the oxidizing agent is selected from the group comprising: oxidizing metal salts, oxidizing metal complexes, peroxides, chlorates, perchlorates, perbromates, periodates, permanganates, sulfates, persulfates, and monopersulfates;
an accelerating agent; and
a complexing agent.

9. A method of planarizing a nickel or nickel-alloy coated substrate, the method comprising:
a) dispensing onto a polishing pad a particle-free polishing fluid comprising an aqueous solution of at least an oxidizing agent, or mixtures thereof, wherein the oxidizing agent is selected from the group comprising: oxidizing metal salts, oxidizing metal complexes, peroxides, chlorates, perchlorates, perbromates, periodates, permanganates, sulfates, persulfates, and monopersulfates;
b) moving the coated substrate to the polishing pad containing the particle-free polishing fluid thereon; and
c) moving the coated substrate relative to the polishing pad to reduce surface roughness of the magnetic disk surface.

10. The method of claim 9, wherein the surface roughness is reduced to less than 1.51 Å.
